(19) United States
(12) Patent Application Publication
(10) Pub. No.: US 2026/0029330 A1
(43) Pub. Date: Jan. 29, 2026

(54) TRANSIENT ELLIPSOMETRY WITH ASYNCHRONOUS OPTICAL SAMPLING

(71) Applicant: Onto Innovation Inc., Wilmington, MA (US)

(72) Inventors: George Andrew Antonelli, Flanders, NJ (US); Manjusha Mehendale, Morristown, NJ (US); Michael J. Kotelyanskii, Chatham, NJ (US); Julien Michelon, Merignac (FR); Xavier Tridon, Bordeaux (FR)

(73) Assignee: Onto Innovation Inc., Wilmington, MA (US)

(21) Appl. No.: 18/784,611

(22) Filed: Jul. 25, 2024

(51) Int. Cl. G01N 21/21; G01N 21/63

(52) U.S. Cl. CPC G01N 21/211; G01N 21/636

(57) ABSTRACT

An optical metrology device configured for transient ellipsometry includes a light source with at least one laser, that generates pump pulses at a first pulse repetition rate and probe pulses at a second, different, pulse repetition rate that produces a varying time delay between the pump pulses and the probe pulses. The pump pulses generate transient perturbations in the sample material and reflected probe pulses are modulated in response to the transient perturbation in the sample material based on the varying time delay. A polarization state generator generates a polarization state in the probe pulses and a polarization state analyzer analyzes the reflected probe pulses from the sample, which is received by a detector. Transient ellipsometric measurements are generated from the reflected probe pulses at a plurality of time delays between the pump pulses and probe pulses.

### FIELD OF THE DISCLOSURE

The subject matter described herein is related generally to ellipsometry, and more particularly to systems and methods for time resolved ellipsometry.

### BACKGROUND

Semiconductor and other similar industries often use optical metrology to provide non-contact evaluation of samples during processing. With optical metrology, a sample under test is illuminated with light, e.g., at a single wavelength or multiple wavelengths. After interacting with the sample, the resulting light is detected and analyzed to determine a desired characteristic of the sample.

There are many different techniques for measuring characteristics of samples such as, for example, semiconductors. One such technique is ellipsometry, in which the polarization change of polarized incident light due to sample materials and geometries is measured from the reflected light. The change in polarization is then related to characteristics of the sample. Another technique is opto-acoustic metrology, in which pump beams generate acoustic waves in a sample, which reflect from layer interfaces and other structures and is returned to a sample surface. Probe beams are generated with varying delay times from the pump beams and measure the reflectivity of the sample, which is affected by the returned acoustic waves. The time resolved reflectivity measurements produced using opto-acoustic metrology may provide information about characteristics of the sample.

While optical metrology techniques, such as ellipsometry and opto-acoustic metrology are useful for analysis of samples, optical metrology devices using such techniques may be improved.

### SUMMARY

An optical metrology device may be configured for transient ellipsometry using asynchronous optical sampling (ASOPS) using a light source with at least one laser to generate pump pulses and probe pulses with different repetition rates to produce varying time delays between the pump pulses and the probe pulses. The pump pulses generate transient perturbations in the sample material and reflected probe pulses are modulated in response to the transient perturbation in the sample material based on the varying time delay. A polarization state generator and polarization state analyzer in the path of the probe beam are used for generating transient ellipsometric measurements due to the varying time delay between the pump and probe pulses.

In one implementation, a method of performing transient ellipsometry for measuring at least one property of a sample includes generating pump pulses at a first pulse repetition rate with at least one laser and generating probe pulses at a second pulse repetition rate with the at least one laser. The second pulse repetition rate is different than the first pulse repetition rate to produce a varying time delay between the pump pulses and the probe pulses. A polarization state is produced in the probe pulses with a polarization state generator. The pump pulses and the probe pulses are caused to be incident on the sample. The pump pulses generate transient perturbations in the sample and reflected probe pulses are modulated in response to a transient perturbation in the sample based on the varying time delay. The reflected probe pulses from the sample are analyzed with a polarization state analyzer and received with a detector. Transient ellipsometric measurements are generated from the reflected probe pulses at a plurality of time delays between the pump pulses and probe pulses.

In one implementation, an optical metrology device configured for performing transient ellipsometry for measuring at least one property of a sample includes a light source with at least one laser. The light source generates pump pulses at a first pulse repetition rate and generates probe pulses at a second pulse repetition rate that is different than the first pulse repetition rate to produce a varying time delay between the pump pulses and the probe pulses. The optical metrology device further includes a polarization state generator that produces a polarization state in the probe pulses and focusing optics that cause the pump pulses and the probe pulses to be incident on the sample. The pump pulses generate transient perturbations in the sample and reflected probe pulses are modulated in response to a transient perturbation in the sample based on the varying time delay. The optical metrology device further includes a polarization state analyzer that analyzes the reflected probe pulses from the sample and a detector that detects the reflected probe pulses from the sample. A computer system is coupled to receive signals from the detector and is configured to generate transient ellipsometric measurements from the reflected probe pulses at a plurality of time delays between the pump pulses and probe pulses.

In one implementation, an optical metrology device configured for performing transient ellipsometry for measuring at least one property of a sample includes a means for generating pump pulses at a first pulse repetition rate and generating probe pulses at a second pulse repetition rate, wherein the second pulse repetition rate is different than the first pulse repetition rate to produce a varying time delay between the pump pulses and the probe pulses. The optical metrology device further includes a means for producing a polarization state of the probe pulses. The optical metrology device further includes focusing optics that cause the pump pulses and the probe pulses to be incident on the sample. The pump pulses generate transient perturbations in the sample, and reflected probe pulses are modulated in response to a transient perturbation in the sample based on the varying time delay. The optical metrology device further includes means for analyzing the reflected probe pulses from the sample. The optical metrology device further includes a detector that detects the reflected probe pulses from the sample, and a means for generating transient ellipsometric measurements from the reflected probe pulses at a plurality of time delays between the pump pulses and probe pulses.

### BRIEF DESCRIPTION OF THE DRA WINGS

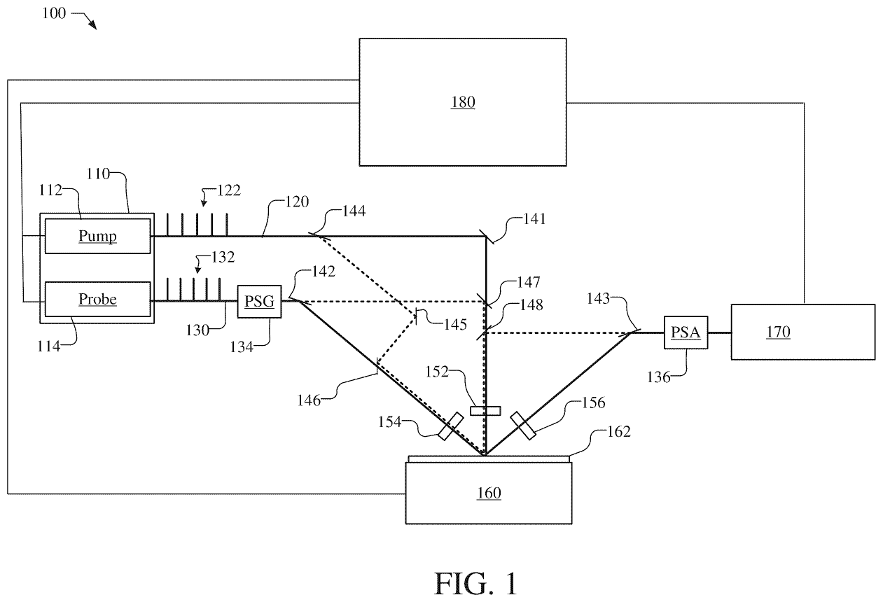

FIG. 1 illustrates a block diagram of an optical metrology device configured to perform transient ellipsometry using pump-probe measurements based on asynchronous optical sampling (ASOPS).

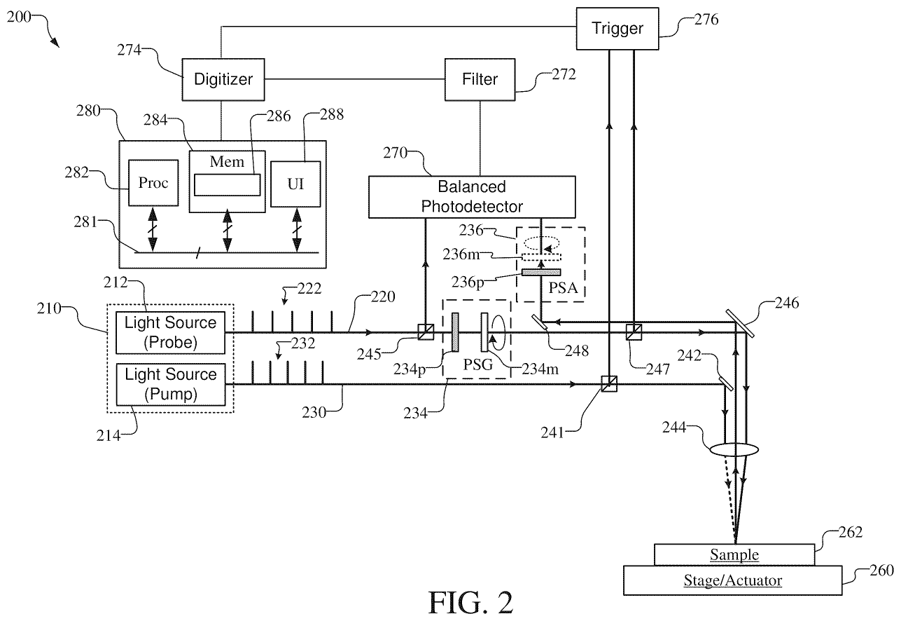

FIG. 2 illustrates a schematic representation of an optical metrology device that illustrates one implementation of the optical metrology device shown in FIG. 1.

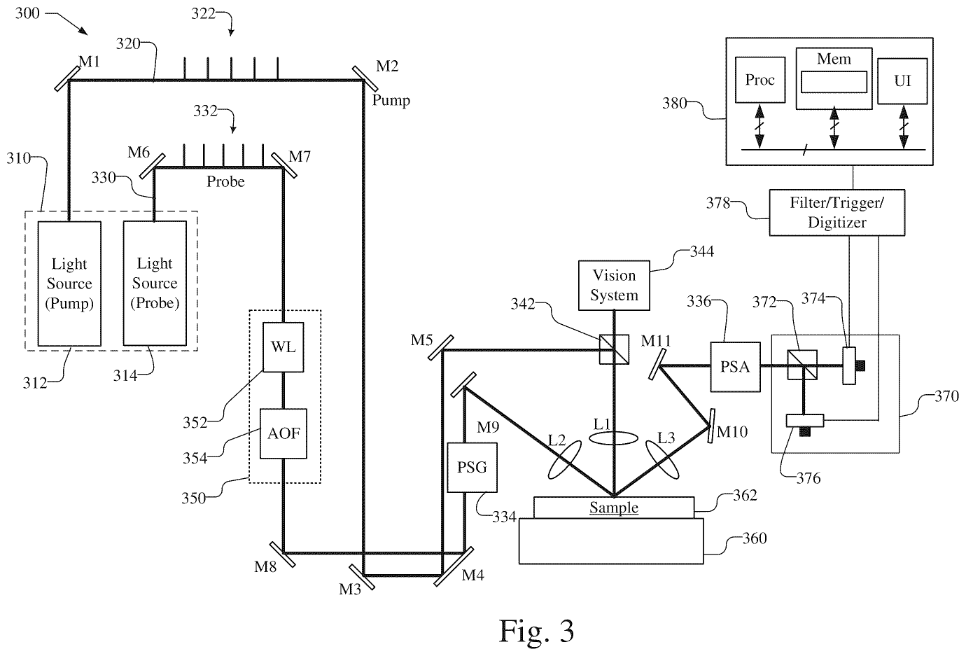

FIG. 3 illustrates a schematic representation of an optical metrology device that illustrates one implementation of the optical metrology device shown in FIG. 1.

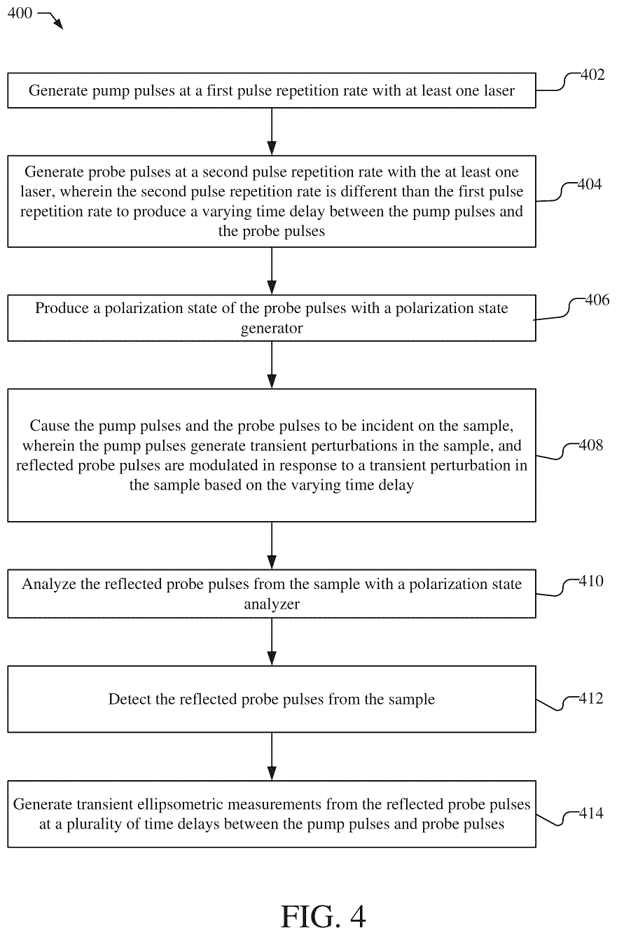

FIG. 4 is a flow chart illustrating a method of operation of an optical metrology device to perform transient ellipsometry using pump-probe measurements based on ASOPS.

### DETAILED DESCRIPTION

During fabrication of semiconductor and similar devices it is sometimes necessary to monitor the fabrication process by non-destructively measuring the devices. Optical metrology is sometimes employed for non-contact evaluation of samples during processing. One type of optical metrology used for characterizing samples is opto-acoustic metrology, which uses ultrafast, e.g., picosecond, optical pump-probe time domain heterodyne differential reflectometry. In opto-acoustic metrology, a pump beam pulse that is incident on the sample produces a transient perturbation, e.g., an acoustic wave, that propagates through the sample. The acoustic wave is reflected by various structures and interfaces within the sample and is returned to the surface of the sample. Material properties at the surface of the sample may be affected by the transient perturbation when returned to the surface of the sample. A probe beam pulse to measure the reflectivity or deflection at the surface of the sample is produced with a controlled time delay after the pump beam pulse. Typically, the time delay is controlled with a mechanical optical delay line. If the probe beam pulse is incident on the surface of the sample when the transient perturbation is returned to the surface of the sample, the reflected probe beam pulse will be affected by change in reflectivity or deflection at the sample surface in response to the returned transient perturbation. In practice, multiple pump and probe beam pulses are produced, with different time delays between the pump/probe pulse pairs, to ensure that one of the probe beam pulses is incident on the sample when the transient perturbation is returned. Various characteristics of the sample may be determined based on the properties of the probe beam as well as the time delay between the pump and probe beam pulses.

The optical pump-probe time domain heterodyne differential reflectometry concept may be extended to perform differential ellipsometry, which may be referred to as transient ellipsometry. Similar to the hardware used for opto-acoustic metrology, the hardware used to perform transient ellipsometry likewise uses an optical delay line to mechanically vary the time delays between pump and probe beam pulses. The probe beam may be phase-modulated with an electro-optic (EOM) or photo-elastic (PEM) modulator and the probe path contains a polarizer and analyzer located before the phase-modulator and before the photodetector respectively. Signals derived from the probe photodetector at multiple modulation frequencies are collected using lock-in amplification. Multiple lock-in amplifiers and demodulators (mixers) may be required to implement the transient ellipsometry system. The use of a mechanical delay line to generate different time delays between the pump and probe beam pulses, however, is relatively slow resulting in a throughput that may be inadequate for production purposes. Moreover, optical delay lines that alter the length of the beam path are mechanical and inherently introduce undesirable vibration and other artifacts into the system. Further, the use of EOM or PEM modulators requires the use of lock-in amplifiers, adding significant expense to the metrology device.

Accordingly, an optical metrology device capable of performing transient ellipsometry without the use of mechanical optical delay lines is desirable to increase throughput as well as minimize vibrations. Further, simplification of the components in the system is desirable to reduce costs.

FIG. 1 illustrates a block diagram of an optical metrology device 100 configured to perform time resolved ellipsometry, sometimes referred to as transient ellipsometry using pump-probe measurements based on asynchronous optical sampling (ASOPS). It should be understood that FIG. 1 illustrates a simplified view of the optical metrology device 100 and that additional optical components, e.g., lenses, polarizers, waveplates, wavelength selectors, etc. may be included.

The optical metrology device 100 includes a pulsed light source 110 that generates a pump beam 120 and a probe beam 130. Any desired laser system capable of producing pump beam 120 and probe beam 130, as discussed herein, may be used as the pulsed light source 110, including a dual laser system or a single laser system. For example, in one implementation, the pulsed light source 110 may be a dual laser system including a pump light source 112 and a probe light source 114, which are mode-locked to produce pump beam 120 and probe beam 130 that are synchronized but have different pulse repetition rates. One of the lasers, e.g., pump light source 112, may operate as the master, and the other laser, e.g., probe light source 114, operates as the slave and is locked with a fixed offset frequency to the other laser. In another implementation, the pulsed light source 110 may be a single laser that produces a separate pump beam 120 and probe beam 130, such as the K2-1000 or K2-ASOPS model lasers, produced by K2 Photonics in Zurich, Switzerland. The pulsed light source 110 may produce the pump beam 120 and probe beam 130 with single wavelengths or a narrowband of wavelengths, which may be the same or may differ from each other, and may produce pulse widths in the range of several hundred femtoseconds to several hundred picoseconds. As an example, but not a limitation, the pulsed light source 110 may produce a pump beam 120 and a probe beam with light in the 400-1 μm range, 50-400 fs pulses with a 20-150 MHz repetition rate.

The pump beam 120 and probe beam 130 are synchronized relative to each other. Instead of mechanically delaying the probe pulses in the probe beam 130 relative to the pump pulses in the pump beam 120 with an optical delay line, as performed in a conventional pump/probe beam optical acoustic device, the frequency of the pulse repetition rates of the pump beam 120 or probe beam 130 differ relative to each other. For example, the pump beam 120 may produce pulses with a 60 MHz repetition rate. The probe beam 130 may be synchronized relative to the pump beam 120, i.e., but has a small offset in the frequency of the repetition rate, e.g., less than 0.05%, 0.02%, or 0.01% of the repetition rate. For example, the probe beam 130 may have a ±9 Khz modification in its nominal 60 Mhz repetition rate. FIG. 1, by way of example, schematically illustrates a plurality of pump pulses 122 of the pump beam 120 with a first pulse repetition rate and illustrates a plurality of probe pulses 132 of the probe beam 130, synchronized to the pump pulses 122, but with a second pulse repetition rate that is different than the first pulse repetition rate. Accordingly, within a full cycle, an initial pump pulse and probe pulse will be emitted at the same time, and each subsequent pulse in the probe beam 130 will have a slightly different delay with respect to a corresponding pulse in the pump beam 120 until the cycle is complete and the pump pulse and probe pulse are again emitted at the same time. Thus, a plurality of different delays between the pump pulses and probe pulses are generated within a single cycle. The lengths of the desired delays may be defined through control of the modification of the pulse repetition rate of the probe beam 130, e.g., with a smaller offset in the frequency of the repetition rate producing more pulses in each cycle with smaller delay times between the pump and probe pulses and, conversely, with a larger offset in the frequency of the repetition rate producing fewer pulses in each cycle with larger delays between the pump and probe pulses. With use of the asynchronous optical sampling (ASOPS) system, the mechanical delay stage is obviated, enabling faster variation of the delay times, thereby increasing throughput, while reducing vibrations and other artifacts produced by a mechanical delay stage.

As illustrated, the pump beam 120 may be directed to be normally incident on the sample 162 held on stage 160 with an optical system, such as mirror 141 and lens 152, while probe beam 130 may be directed to be obliquely incident on the sample 162 with an optical system, such as mirror 142 and lens 154. The probe beam 130 is reflected by the sample 162 and may be received by a detector 170 via lens 156 and mirror 143. In some implementations, the pump beam 120 may be obliquely incident on the sample 162, e.g., using mirrors 144, 145, and 146 and lens 152. Additionally, or alternatively, the probe beam 130 may be normally incident on the sample 162, e.g., using mirror 147 and lens 152 and the reflected probe beam may be received by detector 170 via lens 152 and mirror 148.

Additionally, the optical metrology device 100, which is configured to perform transient ellipsometry, includes a polarization state generator (PSG) 134 and a polarization state analyzer (PSA) 136 within the path of the probe beam 130. The PSG 134, for example, may include a polarizer, which polarizes the probe beam 130 and a phase modulator, which phase modulates the probe beam 130, prior to the probe beam 130 being incident on the sample 162. The phase modulator, for example, may be an electro-optical modulator (EOM), a photoelastic modulator (PEM), an LCD (liquid crystal display) based phase modulator, or a rotating compensator. The PSA 136, for example, may include a polarizer (sometimes referred to as an analyzer), and in some implementations, may also include a phase modulator, such as an EOM, PEM, an LCD based phase modulator, or rotating compensator. The detector 170 may include one or more photodetectors to receive the reflected probe beam after passing through the PSA 136. In some implementations, separate photodetectors may be used in the detector 170 to receive the light in non-collinear polarization states. The detector 170 (or a separate digital processing component) may digitize the detected signal, which is provided to the computer system 180.

A computer system 180 may control operation of the optical metrology device 100, including control operation of the pulsed light source 110, PSG 134, and PSA 136, and may receive signals from the detector 170 and generate ellipsometric measurements from the reflected probe pulses at a plurality of time delays between the pump pulses and probe pulses. For example, the computer system 180 may receive the detected signals over a plurality of cycles of time delays between the pump pulses and probe pulses. Each cycle may be performed at a different polarization state in the PSG 134 and/or PSA 136. In some implementations, the polarization states fixed for each cycle or may be continuously varying during each cycle, e.g., at a significantly decreased frequency than the time delay cycle, so that the polarization states are functionally static during each cycle. The computer system 180, thus, collects data at all desired polarization states from the PSG 134 and PSA 136 over all desired time delays between the probe pulses in the probe beam 130 relative to the pump pulses in the pump beam 120. The computer system 180, accordingly, may generate ellipsometric parameters for each different time delay.

Additionally, the computer system 180 may be connected to and control the stage 160 that holds the sample 162 and includes actuators to move the sample 162 based on controls signals from the computer system 180 to position the sample 162 at desired measurement positions. The stage 160, for example, may be capable of horizontal motion in either Cartesian (i.e., X and Y) coordinates, or Polar (i.e., R and θ) coordinates or some combination of the two. The stage 160 may also be capable of vertical motion along the Z coordinate. The computer system 180 may further control the operation of a chuck on the stage 160 used to hold or release the sample 162. It should be appreciated that the computer system 180 may be a self-contained or distributed computing device capable of performing necessary computations, receiving, and sending instructions or commands and of receiving, storing, and sending information related to the metrology functions of the system.

The computer system 180 includes one or more processors and may be a workstation, a personal computer, central processing unit or other adequate computer system, or multiple systems. It should be understood that computer system 180 includes one processor, multiple separate processors or multiple linked processors that may be used together, all of which may interchangeably be referred to herein as computer system 180, processor 180, at least one processor 180, one or more processors 180. The computer system 180 is preferably included in, or is connected to, or otherwise associated with the optical metrology device 100. The computer system 180, for example, may be configured to control the optical metrology device 100 to obtain the desired optical data and to determine the desired measurements using the optical data, as described herein, and to determine one or more properties of the sample based on the determined measurements.

In some implementations, the optical metrology device 100 may be controlled by computer system 180 to generate static ellipsometry measurements using only the probe beam 130, i.e., by controlling pump light source 112 so that no pump beam is generated or by placing a shutter (not shown) in the path of the pump beam 120. The PSG 134 may be configured to generate one or more desired polarization states of the probe pulses in probe beam 130 and to modulate the phase of the linearly polarized probe beam 130. The linearly polarized light will become elliptically polarized upon reflection from the sample 162 due to the dielectric properties (e.g., complex refractive index or dielectric function) of the materials in the sample 162. The PSA 136 and the detector 170 may be used to detect the polarization state of the reflected probe beam 130 to determine the ellipsometry parameters w and A and/or adapting the Mueller matrix formalism such as looking for off-diagonal elements in some applications. For example, the PSA 136 and one or more photodetectors in the detector 170 may be used to detect non-collinearly polarization states of incident light.

The optical metrology device 100, for example, may perform static ellipsometry using linearly polarized light that is periodically phase modulated, via the modulator in the PSG 134. The modulation may be produced using a rotating compensator as the modulator in the PSG 134. If the phase modulation is performed using, e.g., an EOM or PEM, the reflected signal may be demodulated using a lock-in amplifier. At least a partial Mueller matrix, e.g., the off-diagonal elements, and/or the ellipsometry parameters Y′ and A may be determined, and a full Mueller matrix may be determined if phase modulators are used in the PSG 134 and PSA 136. The reflected light intensity received at the detector 170, which is obtained at different polarization orientations and phase modulations are linearly related to the Mueller matrix of the sample, which is hardware dependent and can be determined by those of ordinary skill in the art in view of the present disclosure, or may be calibrated by using the optical metrology device 100 to measure samples with known properties.

In some implementations, the change in ellipsometric parameters may be compared to a model or library to determine characteristics of the sample 162. Ellipsometry, for example, may be used to determine characteristics of the sample 162, such as composition, roughness, thickness (depth), crystalline nature, doping concentration, electrical conductivity, etc.

In some implementations, the optical metrology device 100 may be controlled by computer system 180 to perform time resolved or transient ellipsometry measurements using both the pump beam 120 and the probe beam 130. Each pump pulse in the pump beam 120 that is incident on the sample 162 produces a transient response in the sample 162. The polarizer in the PSG 134 may be configured to generate one or more desired polarization states of the probe pulses in probe beam 130 and the modulator in the PSG 134 may modulate the phase. Within a single cycle, each of the plurality of probe pulses in the probe beam 130 interact with the sample 162 after a different time delay from a corresponding pulse in the pump beam 120. Thus, within a single cycle, the reflected probe beam may be collected by the 170 and measurements acquired as a function of all time delays between the pulses in the pump beam 120 and the probe beam 130. The reflected probe beams may be collected over multiple cycles at different polarization states and phases produced by the modulator in the PSG 134 (and optionally by a modulator in the PSA 136). Additionally, the reflected probe beams may be collected over multiple cycles at each polarization state and phase to improve the signal to noise ratio. The characteristics of the materials in the sample 162 will alter the polarization state in the probe beam 130 received by the detector 170.

The PSG 134 may be configured to generate one or more desired polarization states of the probe pulses in probe beam 130, and the modulator may modulate the phase of the probe beam 130. A probe beam 130 pulse interacts with the sample 162 after each pulse in the pump beam 120. The transient ellipsometry measurements may be collected as a function of the time delay between the pulses in the pump beam 120 and the pulses in the probe beam 130. The characteristics of the materials in the sample 162 will alter the polarization state in the received probe beam as a function of the time delay. The PSG 134 and PSA 136 and detector 170 may be used to detect the polarization state of the reflected probe beam 130 to determine the perturbation produced in the sample in a time resolved manner. By way of example, the PSG 134 and PSA 136 and detector 170 may be used to determine at least a partial Mueller matrix, e.g., the off-diagonal elements, and/or to determine the ellipsometry parameters Y′ and A, or to determine a full Mueller matrix if phase modulators are used in the PSG 134 and PSA 136, at different pump-probe delay times. For example, the PSG 134 and PSA 136 and detector 170 may be used to generate and detect light in varying polarization states at different pump-probe delay times. The modulation may also be produced using a rotating compensator as the modulator in the PSG 134. If phase modulation is used, the reflected signal may be demodulated using a lock-in amplifier, or by digitally applied Fourier transforms at a set of higher harmonics of the frequency of the modulation or rotation.

Thus, the optical metrology device 100 may perform transient ellipsometry using a pump beam 120 and using probe beam 130 that is linearly polarized light and is periodically phase modulated, via the modulator in the PSG 134. The modulation may be produced using a rotating compensator as the modulator in the PSG 134. If the phase modulation is performed using, e.g., an EOM or PEM, the reflected signal may be demodulated using a lock-in amplifier. For a plurality of time delays between the pump pulses and probe pulses, at least a partial Mueller matrix, e.g., the off-diagonal elements, and/or the ellipsometry parameters Y′ and A may be determined, and a full Mueller matrix may be determined if phase modulators are used in the PSG 134 and PSA 136. The reflected light intensity received at the detector 170, which is obtained at different polarization orientations and phase modulations are linearly related to the Mueller matrix of the sample, which is hardware dependent and can be determined by those of ordinary skill in the art in view of the present disclosure, or may be calibrated by using the optical metrology device 100 to measure samples with known properties. As is well known in the art, different subsets of Mueller matrix elements may be sampled with different configurations of the polarizers and modulators. A complete set of 16 elements of the full Mueller Matrix may be studied without changing azimuths of any other optical elements using dual rotating compensators in the PSG 134 and PSA 136. The rotating compensators may sample the polarization states in a discrete manner so that the timing between every step in the rotating compensator may be some integer value of 1/(fₚᵤₘₚ−f_{probe}), where fₚᵤₘₚ is the pump frequency (i.e., pulse repetition rate (pulses/second)) and f_{probe} is the probe frequency (i.e., pulse repetition rate (pulses/second)), e.g., the compensator period Tc=m (1/(fₚᵤₘₚ−f_{probe}), where m is an integer. A continuously rotating compensator may be used with the rotating frequency synchronized with the beat frequency of the of the pump and probe pulses. The two rotating compensators may have different frequencies that are not integers of each other.

The computer system 180 may be configured to determine the desired measurements, such as the transient ellipsometric measurements, and optionally the static ellipsometric measurements, as discussed herein. The computer system 180 may be further configured to determine one or more properties of the sample based on the determined measurements. For example, the computer system 180 may be configured to compare the determined measurements, e.g., transient ellipsometric measurements, to a model of the sample including simulated signals that correspond to a representation of the sample. The model may be generated in real-time or stored in a library. The model parameters, e.g., various parameters of the sample and corresponding simulated signals may be altered and fit to the determined transient ellipsometric measurements to minimize a difference, in order to find a best fit. The values of the parameters of the model that correspond to the best fit may be determined to be the at least one property of the sample. Other techniques for determining one or more properties of the sample based on the determined measurements may be used, such as machine learning.

With the use of a rotating compensator in the PSG 134 (and optionally in the PSA 136), the compensator rotation may be linked to the cycles of the pulsed light source 110 allowing data to be collected at particular points in the rotation of the compensator, thereby avoiding the need for the use of lock-in amplifiers in the detection system, thereby reducing the costs of the device. Moreover, with the use of ASOPS data collection for all probe delays set by the repetition rate of the pulsed light source 110, all data may be collected on the order of hundreds of microseconds. For example, collection time may be on the order of 10 ms, with 100 averages used to improve the signal-to-noise, resulting in a measurement time of 1 s. Accordingly, four compensator positions may be measured in approximately 4 s or less. The simplicity of the hardware of the optical metrology device 100 provides a high throughput and resistance to vibration as there are no moving parts.

FIG. 2 illustrates a schematic representation of an optical metrology device 200, which illustrates one implementation of the optical metrology device 100 shown in FIG. 1. It should be understood that the optical metrology device 200 may include components and subsystems in addition to those illustrated in FIG. 2, such as beam management and conditioning components, such as beam expanders, collimators, polarizers, half-wave plates, wavelength selectors, etc., as well as a beam power detector, and focus sensor, etc. Further, while optical metrology device 200 is illustrated as using normally incident pump and probe beams, the optical metrology device 200 may include additional optical components, such as mirrors, to alter the angle of incidence of one or both of the pump beam and probe beam. Moreover, it should be understood that certain components illustrated in FIG. 2 may not be included in the optical metrology device 200 if the specific component are unnecessary for performing desired metrology techniques described herein.

As illustrated, a light source 210 produces a pulsed pump beam 220 and a pulsed probe beam 230. The light source 210, for example, may include two separate light sources, e.g., pump light source 212 and probe light source 214, or a single laser source that produces two separate mode locked beams, as discussed in FIG. 1. The pump beam 220 and probe beam 230 have slightly different repetition rates, e.g., with a difference of less than 0.05%, 0.02%, or 0.01%, or any other desired amount adequate to produce desired variations in time delays between the pump pulses 222 and probe pulses 232.

The pump beam 220 is directed to the sample 262 held on stage 260 via one or more optical elements, such as mirror 242 and lens 244. The probe beam 230 is likewise directed to the sample 262 via one or more optical elements, such as mirror 246 and lens 244. The probe beam 230 further passes through a PSG 234, which includes a polarizer 234p and a phase modulator 234m. The phase modulator 234m, for example, may be a rotating compensator, or if desired, may be an EOM, AOM, or other appropriate device.

The reflected probe beam 230 is received by a detector 270 after passing through a PSA 236, which includes a polarizer 236p. The PSA 236 may further include a phase modulator 236m (illustrated with dotted lines), which may be a rotating compensator, or if desired, may be an EOM, AOM, or other appropriate device. As illustrated, the reflected probe beam 230 may be returned to the detector 270 via one or more optical elements, such as lens 244, mirror 246, and mirror 248, although other arrangements and other optical elements may be used, e.g., if the probe beam 230 is obliquely incident on the sample 262. The pump beam 220 and the probe beam 230 may be focused at the same location (e.g., coincident spots) on the sample 262, e.g., for bulk measurements, or may be focused at separate (e.g., non-coincident spots) on the sample 262, e.g., for surface measurements. As discussed above, each pump pulse in the pump beam 220 generates a transient perturbation at the surface of the sample 262 that propagates through the sample and is reflected and returned to the surface by underlying structures, such as layer interfaces. The probe beam 230 reflected from the surface of the sample 262 will be affected by the returned transient perturbation if the probe beam pulse is incident on the sample 262 when the perturbation is returned. For surface measurements, the transient perturbation traverses the surface of the sample from the location of the pump beam to the location of the probe beam.

The detector 270, for example, include one or more photodetectors, to sample two non-collinear, preferably orthogonal, polarization states. The detector 270 may be balanced photodetector that receives a portion of the probe beam 230 prior to being incident on the sample 262, e.g., via beam splitter 245, and receives the reflected probe beam 230 via mirror 248. The use of a balanced photodetector may be advantageous, for example, to control for noise in the probe beam 230 produced by the light source 210. The output of the detector 270 may be coupled to a filter 272, which may be used to filter particular frequencies, e.g., high frequencies, that may be problematic for the digitizer 274. The digitizer 274 may be a high speed digitizer that receives, processes and records digitally information from the detector 270. The digitizer 274 may be controlled by a trigger 276 that receives a portion of the pump beam 220 and the probe beam 230, via beam splitters 241 and 247, respectively, to detect the beginning of a new cycle, i.e., when the pump and probe pulses are emitted at the same time. The pump pulses 222 and probe pulses 232 have slightly different repetition rates. Accordingly, at the beginning of a cycle, the pump and probe pulses will be emitted at the same time, and subsequently pump and probe pulses will have increasing time delays between them until the cycle is complete and the pump and probe pulses are again emitted at the same time. Thus, within a cycle, each probe pulse will be incident on the surface of the sample 262 after the preceding pump pulse after a slightly different time delay. The trigger 276 is used to trigger the digitizer 274 to record measurements for each cycle.

The computing system 280, which may be the same as computing system 180 shown in FIG. 1, is configured to receive and analyze the data from the digitizer 274 to determine one or more parameters of the sample. The computing system 280 may be further configured to control the movement of a stage 260 holding the sample 262 and/or the including the optical system, using one more actuators. The stage 260, for example, may be capable of horizontal motion in either Cartesian (i.e., X and Y) coordinates or Polar (i.e., R and θ) coordinates or some combination of the two. The stage 260 and/or optical head may also be capable of vertical motion, e.g., for focusing.

The computing system 280, for example, may be a workstation, a personal computer, central processing unit or other adequate computer system, or multiple systems. It should be understood that the computing system 280 may be a single computer system or multiple separate or linked computer systems, which may be interchangeably referred to herein as computing system 280, at least one computing system 280, one or more computing systems 280. The computing system 280 may be included in or is connected to or otherwise associated with optical metrology device 200. Different subsystems of the optical metrology device 200 may each include a computing system that is configured for carrying out steps associated with the associated subsystem.

The computing system 280 includes at least one processor 282 with memory 284, as well as a user interface (UI) 288, which are communicatively coupled via a bus 281. The memory 284 or other non-transitory computer-usable storage medium, includes computer-readable program code 286 embodied thereof and may be used by the computing system 280 for causing the one or more computing systems 280 to control the optical metrology device 100 and to perform the functions discussed herein. The memory 284 may further include computer-readable program code 286 or instructions for causing the processor 282 to analyze the data to determine one or more parameters of the sample 262 based on the received signals. The results of the analysis of the data, e.g., to characterize the parameters of a sample 262 may be reported, e.g., stored in memory 284 associated with the sample 262 and/or indicated to a user via UI 288, an alarm or other output device. Moreover, the results from the analysis may be reported and fed forward or back to the process equipment to adjust the appropriate fabrication steps to compensate for any detected variances in the fabrication process. The computing system 280, for example, may include a communication port that may be any type of communication connection, such as to the internet or any other computer network. The communication port may be used to receive instructions that are used to program the computing system 280 to perform any one or more of the functions described herein and/or to export signals, e.g., with measurement results and/or instructions, to another system, such as external process tools, in a feed forward or feedback process in order to adjust a process parameter associated with a fabrication process step of the samples based on the measurement results.

The data structures and software code for automatically implementing one or more acts described in this detailed description can be implemented by one of ordinary skill in the art in light of the present disclosure and stored, e.g., on a computer-usable storage medium, e.g., memory 284, which may be any device or medium that can store code and/or data for use by the computing system 280. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

FIG. 3 illustrates a schematic representation of an optical metrology device 300, which illustrates an implementation of the optical metrology device 100 shown in FIG. 1. Optical metrology device 300, for example, may be similar to the optical metrology device 200 shown in FIG. 2, but illustrates an obliquely incident probe beam. FIG. 3 further illustrates additional optical components, such as wavelength selector that may be used to select one or more wavelengths to be used in the probe beam for measurement of the sample, which may be used with optical metrology device 300, as well as optical metrology devices 100 and 200, shown in FIGS. 1 and 2, respectively. It should be understood that the optical metrology device 300 may include additional components and subsystems, such as beam management and conditioning components, such as beam expanders, collimators, polarizers, half-wave plates, etc., as well as a beam power detector, and focus sensor, etc. Moreover, it should be understood that certain components illustrated in FIG. 2 may not be included in the optical metrology device 300 if the specific component are unnecessary for performing desired metrology techniques described herein.

Optical metrology device 300, similar to optical metrology device 200, includes a light source 310 that produces a pulsed pump beam 320 and a pulsed probe beam 330. The light source 310 may include two separate light sources, e.g., pump light source 312 and probe light source 314, which may be mode locked lasers. In other implementations, a single laser source may be used that produces two separate mode locked beams. The pump beam 320 and probe beam 330 have slightly different repetition rates to produce desired variations in time delays between the pump pulses 322 and probe pulses 332.

As illustrated, the pump beam 320 may be directed to the sample 362 held on stage 360 via one or more optical elements, such as mirror M1, M2, M3, M4, M5, beam splitter 342 and lens L1. A vision system 344 may focus on the sample 362 via the beam splitter 342 and lens L1 and may be used for positioning the sample 362.

The probe beam 330 may be directed to the sample 362 via one or more optical elements, such as mirrors M6, M6, M8, M4, M9, and lens L2. The probe beam 330 further passes through a PSG 334, which may include a polarizer and a phase modulator, such as a rotating compensator, EOM, AOM, or other appropriate device. The probe beam 330 may be incident on the sample 362 at the same location as the pump beam 320 for bulk measurements or at a nearby location for surface measurements.

The obliquely incident probe beam 330 is reflected from the sample 362 and is directed to a detector 370 via lens L3, and mirrors M10 and M11, and after passing through PSA 336, which includes a polarizer and optionally a phase modulator, such as a rotating compensator, EOM, AOM, or other appropriate device. The detector 370, by way of example, may include a polarized beam splitter 372 for directing P polarized light and S polarized light to photodetectors 374 and 376, respectively. The output of the detector 370 may be coupled to a digital processor 378, which may include a filter, trigger and digitizer, as discussed in FIG. 2. The output of the digital processor 378 may be coupled to the computer system 380 that is configured to receive and analyze the data to determine one or more parameters of the sample, and may be further configured to control operation of the optical metrology device 300.

Additionally, a wavelength selector 350 may be used to select one or more wavelengths in the probe beam for measurement of the sample 362. The wavelength selector 350, for example, may include a multi-wavelength generator 352 that receives the probe beam 330, which is narrowband, and spectrally broadens the probe beam 330. The multi-wavelength generator 352, for example, may be a supercontinuum generator, such as multiple harmonic generator, e.g., a DBO or photonic crystal fibers that receive a single or narrowband of wavelengths and produce multiple wavelengths in a continuous or dis-continuous spectrum wavelengths for the probe beam. For example, a DBO or photonic crystal fibers may be used. The multi-wavelength generator 352 enables an ability to increase the wavelengths of the probe beam 330, e.g., from visible to near infrared spectral range, which may be continuous or discontinuous wavelengths, and which may be used for spectroscopic measurement of the sample 362 or may be filtered to select a particular wavelength or narrowband of wavelengths for measurement of the sample 362. The wavelength selector 350, in some implementations, may further include a filter 354, such as an acousto-optic filter, that when used with the multi-wavelength generator 352 enables an ability to select one or more specific wavelengths to be included in the probe beam 330, e.g., from visible to near infrared spectral range to be used for measuring a sample 362.

FIG. 4 is a flow chart 400 illustrating a method of operation of an optical metrology device, such as optical metrology device 100, 200, or 300 to perform transient ellipsometry for measuring at least one property of a sample, as discussed herein.

At block 402, the optical metrology device generates pump pulses at a first pulse repetition rate with at least one laser, e.g., as illustrated by pulsed light source 110 producing a pump beam 120 with a plurality of pump pulses 122 in FIG. 1, and similarly illustrated in FIGS. 2 and 3. A means for generating pump pulses at a first pulse repetition rate with at least one laser may include, e.g., any of the pulsed light sources 110, 210, and 310 in FIGS. 1, 2, and 3, respectively.

At block 404, the optical metrology device generates probe pulses at a second pulse repetition rate with the at least one laser, wherein the second pulse repetition rate is different than the first pulse repetition rate to produce a varying time delay between the pump pulses and the probe pulses, e.g., as illustrated by pulsed light source 110 producing a probe beam 130 with a plurality of probe pulses 132 in FIG. 1, and similarly illustrated in FIGS. 2 and 3. A means for generating probe pulses at a second pulse repetition rate with the at least one laser, wherein the second pulse repetition rate is different than the first pulse repetition rate to produce a varying time delay between the pump pulses and the probe pulses may include, e.g., any of the pulsed light sources 110, 210, and 310 in FIGS. 1, 2, and 3, respectively.

At block 406, the optical metrology device produces a polarization state of the probe pulses with a polarization state generator, e.g., as illustrated by PSG 134 in FIG. 1, and similarly illustrated in FIGS. 2 and 3. A means for producing a polarization state of the probe pulses with a polarization state generator may include, e.g., any of the PSGs 134, 234, and 334 in FIGS. 1, 2, and 3, respectively.

At block 408, the optical metrology device causes the pump pulses and the probe pulses to be incident on the sample, wherein the pump pulses generate transient perturbations in the sample, and reflected probe pulses are modulated in response to a transient perturbation in the sample based on the varying time delay, e.g., as illustrated by lenses 152 and 154 and the incidence pump beam 120 and probe beam 130 on sample 162 in FIG. 1, and similarly illustrated in FIGS. 2 and 3. A means for causing the pump pulses and the probe pulses to be incident on the sample, wherein the pump pulses generate transient perturbations in the sample, and reflected probe pulses are modulated in response to a transient perturbation in the sample based on the varying time delay may include, e.g., any of the optical elements, including mirrors and lenses illustrated in in FIGS. 1, 2, and 3, respectively.

At block 410, the optical metrology device analyzes the reflected probe pulses from the sample with a polarization state analyzer, e.g., as illustrated by PSA 136 in FIG. 1, and similarly illustrated in FIGS. 2 and 3. A means for analyzing the reflected probe pulses from the sample with a polarization state analyzer may include, e.g., any of the PSAs 136, 236, and 336 in FIGS. 1, 2, and 3, respectively.

At block 412, the optical metrology device detects the reflected probe pulses from the sample, e.g., as illustrated by detector 170 in FIG. 1, and similarly illustrated in FIGS. 2 and 3. A means for detecting the reflected probe pulses from the sample may include, e.g., any of the detectors 170, 270, and 370 in FIGS. 1, 2, and 3, respectively.

At block 414, the optical metrology device generates transient ellipsometric measurements from the reflected probe pulses at a plurality of time delays between the pump pulses and probe pulses, e.g., as illustrated by computer system 180 in FIG. 1, and similarly illustrated in FIGS. 2 and 3. A means for generating transient ellipsometric measurements from the reflected probe pulses at a plurality of time delays between the pump pulses and probe pulses may include, e.g., any of the computer system 180, 280, and 380 in FIGS. 1, 2, and 3, respectively.

In some implementations, the optical metrology device determines the at least one property of the sample based on the transient ellipsometric measurements, e.g., as illustrated by computer system 180 in FIG. 1, and similarly illustrated in FIGS. 2 and 3. For example, the transient ellipsometric measurements may be compared simulated signals for a physical model of the sample and its properties, and the model parameters and corresponding simulated signals may be fit to transient ellipsometric measurements to minimize a difference in order to obtain the values of the at least one property of the sample. A means for determining the at least one property of the sample based on the transient ellipsometric measurements may include, e.g., any of the computer system 180, 280, and 380 in FIGS. 1, 2, and 3, respectively.

In some implementations, the polarization state generator may include a first polarizer and the polarization state analyzer may include a second polarizer, e.g., as illustrated by polarizers 234p and 236p in FIG. 2. At least one of the polarization state generator and the polarization state analyzer may include a rotating compensator, e.g., as illustrated by modulators 234m and 236m in FIG. 2. For example, the polarization state generator may include a first rotating compensator and the polarization state analyzer may include a second rotating compensator, e.g., as illustrated by modulators 234m and 236m in FIG. 2. The first rotating compensator and the second rotating compensator may rotate with different frequencies and the transient ellipsometric measurements may include perturbations to all 16 elements of a full Mueller Matrix.

In some implementations, the method may include receiving a portion of the probe pulses with a balanced photodetector before the probe pulses are incident on the sample, e.g., as illustrated with beam splitter 245 and detector 270 in FIG. 2. The detecting the reflected probe pulses from the sample may include receiving the probe pulses reflected from the sample with the balanced photodetector as illustrated in FIG. 2.

The pump pulses and the probe pulses may be caused to be incident on the sample by causing the pump pulses to be incident on the sample at normal incidence using a first set of optical elements and causing the probe pulses to be incident on the sample at oblique incidence with a second set of optical elements, e.g., as illustrated in FIGS. 1 and 3. A means for causing the pump pulses to be incident on the sample at normal incidence using a first set of optical elements may include, e.g., mirror 141 and lens 152 in FIG. 1 and one or more mirrors M1, M2, M3, M4, M5, beam splitter 342, and lens L1 in FIG. 3, and a means for causing the probe pulses to be incident on the sample at oblique incidence with a second set of optical elements may include, e.g., mirror 142 and lens 154 in FIG. 1 and one or more mirrors M6, M7, M8, M4, M9, and lens L2 in FIG. 3.

The pump pulses and the probe pulses may be caused to be incident on the sample by causing the pump pulses and the probe pulses to be incident on the sample at a same angle of incidence, e.g., as illustrated in FIGS. 1 and 2. A means for causing the pump pulses and the probe pulses to be incident on the sample at a same angle of incidence may include, e.g., one or more of mirrors 142, 144, 145, 146, and lens 154, or mirrors 141 and 147 and lens 152 in FIG. 1 or one or more of mirrors 242 and 246 and lens 244 in FIG. 2.

The at least one laser may include a first laser and a second laser that is mode locked to the first laser, e.g., as illustrated by pump light sources 112, 212, and 312 and probe light sources 114, 214, and 314, shown in FIGS. 1, 2, and 3.

The method may further include digitizing signals received from detected reflected probe pulses from the sample, wherein the transient ellipsometric measurements are generated based on the digitized signals, e.g., as illustrated in FIGS. 2 and 3. A means for digitizing signals received from detected reflected probe pulses from the sample, wherein the transient ellipsometric measurements are generated based on the digitized signals may include, e.g., the digitizer 274 in FIG. 2 or digital processor 378 in FIG. 3.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the broadest scope consistent with this disclosure, the principles and the novel features disclosed herein.

What is claimed is:

1. A method of performing transient ellipsometry for measuring at least one property of a sample, the method comprising:
generating pump pulses at a first pulse repetition rate with at least one laser;
generating probe pulses at a second pulse repetition rate with the at least one laser, wherein the second pulse repetition rate is different than the first pulse repetition rate to produce a varying time delay between the pump pulses and the probe pulses;
producing a polarization state of the probe pulses with a polarization state generator;
causing the pump pulses and the probe pulses to be incident on the sample, wherein the pump pulses generate transient perturbations in the sample, and reflected probe pulses are modulated in response to a transient perturbation in the sample based on the varying time delay;
analyzing the reflected probe pulses from the sample with a polarization state analyzer;
detecting the reflected probe pulses from the sample; and
generating transient ellipsometric measurements from the reflected probe pulses at a plurality of time delays between the pump pulses and probe pulses.

2. The method of claim 1, further comprising determining the at least one property of the sample based on the transient ellipsometric measurements.

3. The method of claim 1, wherein the polarization state generator comprises a first polarizer and the polarization state analyzer comprises a second polarizer, and wherein at least one of the polarization state generator and the polarization state analyzer comprises a rotating compensator.

4. The method of claim 3, wherein the polarization state generator comprises a first rotating compensator and the polarization state analyzer comprises a second rotating compensator, and wherein the first rotating compensator and the second rotating compensator rotate with different frequencies, wherein the transient ellipsometric measurements comprise perturbations to all 16 elements of a full Mueller Matrix.

5. The method of claim 1, further comprising:
receiving a portion of the probe pulses with a balanced photodetector before the probe pulses are incident on the sample;
wherein detecting the reflected probe pulses from the sample comprises receiving the probe pulses reflected from the sample with the balanced photodetector.

6. The method of claim 1, wherein causing the pump pulses and the probe pulses to be incident on the sample comprises:
causing the pump pulses to be incident on the sample at normal incidence using a first set of optical elements; and
causing the probe pulses to be incident on the sample at oblique incidence with a second set of optical elements.

7. The method of claim 1, wherein causing the pump pulses and the probe pulses to be incident on the sample comprises causing the pump pulses and the probe pulses to be incident on the sample at a same angle of incidence.

8. The method of claim 1, wherein the at least one laser comprises a first laser and a second laser that is mode locked to the first laser.

9. The method of claim 1, further comprising digitizing signals received from detected reflected probe pulses from the sample, wherein the transient ellipsometric measurements are generated based on digitized signals.

10. An optical metrology device configured for performing transient ellipsometry for measuring at least one property of a sample, the optical metrology device comprising:
a light source comprising at least one laser, the light source generating pump pulses at a first pulse repetition rate and generating probe pulses at a second pulse repetition rate, wherein the second pulse repetition rate is different than the first pulse repetition rate to produce a varying time delay between the pump pulses and the probe pulses;
a polarization state generator that produces a polarization state in the probe pulses;
focusing optics that cause the pump pulses and the probe pulses to be incident on the sample, wherein the pump pulses generate transient perturbations in the sample, and reflected probe pulses are modulated in response to a transient perturbation in the sample based on the varying time delay;
a polarization state analyzer that analyzes the reflected probe pulses from the sample;
a detector that detects the reflected probe pulses from the sample; and
a computer system coupled to receive signals from the detector and configured to generate transient ellipsometric measurements from the reflected probe pulses at a plurality of time delays between the pump pulses and probe pulses.

11. The optical metrology device of claim 10, wherein the computer system is further configured to determine the at least one property of the sample based on the transient ellipsometric measurements.

12. The optical metrology device of claim 10, wherein the polarization state generator comprises a first polarizer and the polarization state analyzer comprises a second polarizer, and at least one of the polarization state generator and the polarization state analyzer comprises a rotating compensator.

13. The optical metrology device of claim 12, wherein the polarization state generator comprises a first rotating compensator and the polarization state analyzer comprises a second rotating compensator, and wherein the first rotating compensator and the second rotating compensator rotate with different frequencies, wherein the transient ellipsometric measurements comprise perturbations to all 16 elements of a full Mueller Matrix.

14. The optical metrology device of claim 10, wherein the detector comprises a balanced photodetector that receives a portion of the probe pulses before the probe pulses are incident on the sample, and receives the reflected probe pulses from the sample.

15. The optical metrology device of claim 10, wherein the focusing optics comprise a first set of optical elements that cause the pump pulses to be incident on the sample at normal incidence and a second set of optical elements that cause the probe pulses to be incident on the sample at oblique incidence.

16. The optical metrology device of claim 10, wherein the focusing optics comprise a set of optical elements that cause the pump pulses and the probe pulses to be incident on the sample at a same angle of incidence.

17. The optical metrology device of claim 10, wherein the light source comprises a first laser and a second laser that is mode locked to the first laser.

18. The optical metrology device of claim 10, further comprising a digitizer that receives signals from the detector and digitizes the signals, wherein the computer system receives digitized signals and generates the transient ellipsometric measurements based on the digitized signals.

19. An optical metrology device configured for performing transient ellipsometry for measuring at least one property of a sample, the optical metrology device comprising:
a means for generating pump pulses at a first pulse repetition rate and generating probe pulses at a second pulse repetition rate, wherein the second pulse repetition rate is different than the first pulse repetition rate to produce a varying time delay between the pump pulses and the probe pulses;
means for producing a polarization state of the probe pulses;
focusing optics that cause the pump pulses and the probe pulses to be incident on the sample, wherein the pump pulses generate transient perturbations in the sample, and reflected probe pulses are modulated in response to a transient perturbation in the sample based on the varying time delay;
means for analyzing the reflected probe pulses from the sample;
a detector that detects the reflected probe pulses from the sample; and
means for generating transient ellipsometric measurements from the reflected probe pulses at a plurality of time delays between the pump pulses and probe pulses.

20. The optical metrology device of claim 19, wherein at least one of the means for producing a polarization state of the probe pulses and the means for analyzing the reflected probe pulses comprises a rotating compensator.
